(19) United States
(12) Patent Application Publication
(10) Pub. No.: US 2011/0243640 A1
(43) Pub. Date: Oct. 6, 2011

(54) WIRE MARKING DEVICE AND METHOD OF USING SAME

(76) Inventor: Richard W. Bogert, Pasco, WA (US)

(21) Appl. No.: 13/081,108

(22) Filed: Apr. 6, 2011

Related U.S. Application Data
(60) Provisional application No. 61/321,468, filed on Apr. 6, 2010.

(51) Int. Cl. B43K 23/00

(52) U.S. Cl. 401/193

(57) ABSTRACT

A device and method for holding a writing implement, such as a marker, and placing markings on an elongated object such as electrical wire and cables.

### CROSS-REFERENCE TO RELATED APPLICATION

This application claims the benefit under 35 U.S.C. §119(e) of U.S. Provisional Patent Application No. 61/321,468 filed Apr. 6, 2010. This provisional application is incorporated herein by reference in its entirety.

### BACKGROUND

1. Technical Field

The present disclosure generally relates to a device for holding a writing implement, such as a marker, and placing markings on an elongated object such as electrical wire and cables, and a method for using the device.

2. Description of the Related Art

Devices used for marking electrical wires are generally known. When building, moving or repairing an electrical system, such as in a home, boat, car, or any location where wires are located, it is desirable to mark wires for identification so that the proper wires get routed to the appropriate location and attached to the proper terminal. Devices known for marking electrical wire include metal or plastic tags and identification sleeves that attach to the wire. Such identification devices and methods are limited in that they require numerous smaller pieces, such as the tags or identification sleeves and connectors for the wire, do not mark long sections of the wire, and are not simple to use by a person that needs to quickly and efficiently mark either long or short sections of wire.

### BRIEF DESCRIPTION OF THE SEVERAL VIEWS OF THE DRAWINGS

FIG. 1 is an isometric view of a wire marking device being used to mark a wire according to an embodiment.

FIG. 2 is a top cross sectional view of a wire marking device being used to mark a wire according to an embodiment.

FIG. 3 is an isometric cross sectional view of a wire marking device and an isometric view of a marker according to an embodiment.

FIG. 4 is a cross-sectional side view of a wire marking device with a marker inserted into the device and a wire outside the device according to an embodiment.

FIG. 5 is a cross-sectional side view of a wire marking device with a marker and a wire inserted into the device according to an embodiment.

FIG. 6 is a cross-sectional side view of a wire marking device being used to mark a wire according to an embodiment.

FIG. 7 is an isometric view of a storage case holding a wire marking device and markers according to an embodiment side.

FIG. 8 is cross-sectional view of a wire marking device with a marker and wire in the device, with the marker marking the wire, according to an embodiment.

FIG. 9 is an isometric view of a wire marking device having contours for improved grip, according to an embodiment.

### DETAILED DESCRIPTION

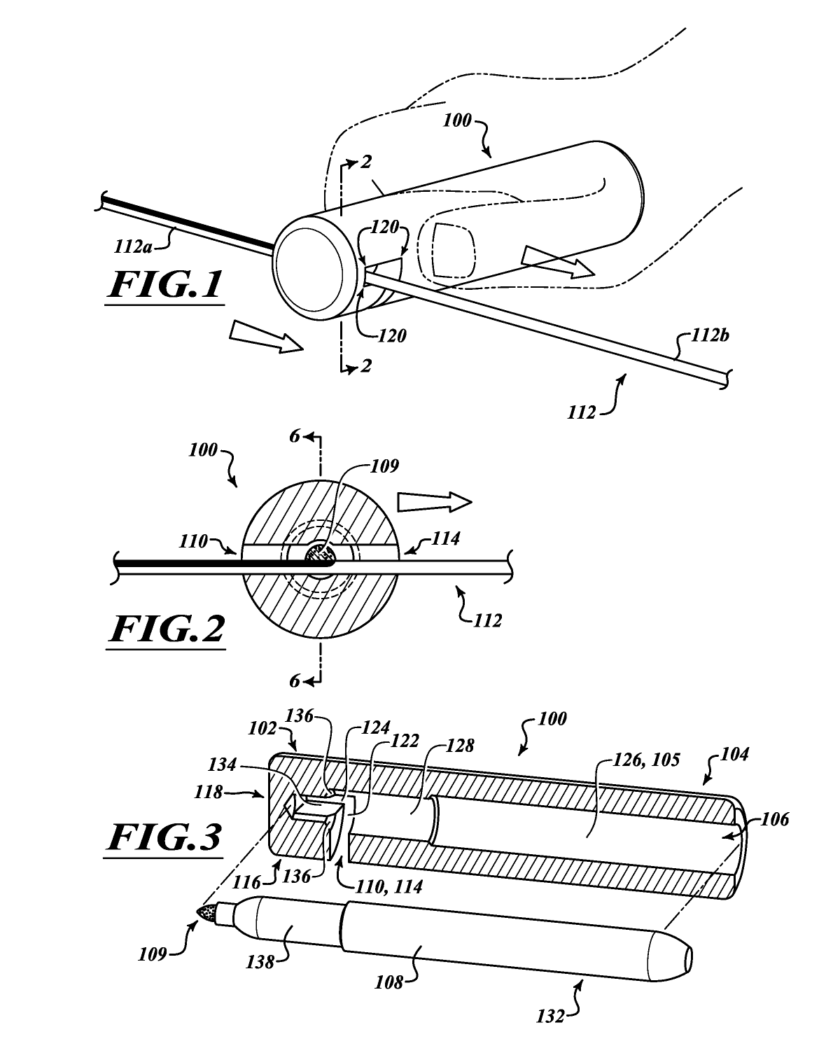

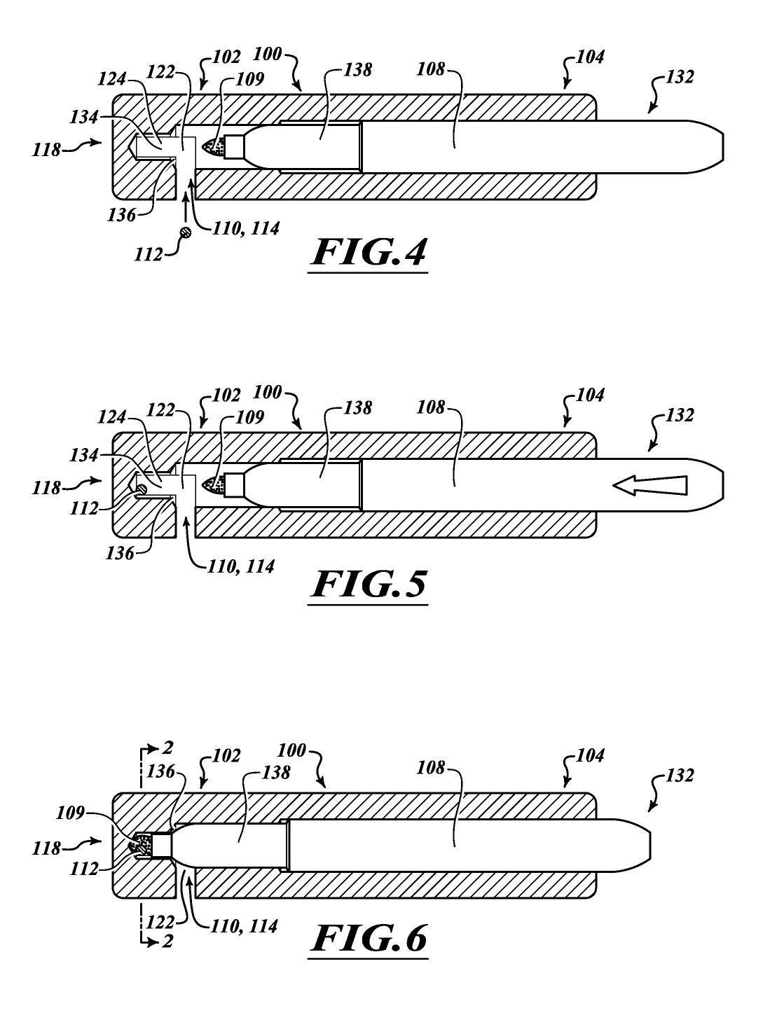

FIGS. 1-9 illustrate a wire marking device 100 according to embodiments. The wire marking device 100 can be made of a resilient material, for example plastic or PVC. In embodiments, the wire marking device 100 can be constructed by injection molding. In other embodiments, the wire marking device can be constructed out of a solid piece of plastic or PVC by drilling and milling.

The device 100 has an elongated body with a front end 102, back end 104, and circular cross-section with a tubular passage 105. The back end 104 has a circular marker opening 106 for the insertion of a marker 108, such as a pen or permanent marker, into the tubular passage 105. The tubular passage 105 is configured to hold the marker 108 in a fixed position such that a marking end 109 of the marker 108 is held within the front end 102 of the device 100. The front end 102 has a wire entry opening 110 configured to slidably receive a wire 112, such that when the wire 112 is engaged within the wire entry opening 110, the marking end 109 of the writing device 100 touches the wire 112 and marks the wire 112 as the device 100 is slid along the length of the wire 112. For example, in FIGS. 1 and 2, the wire 112 has marked area 112a and unmarked area 112b, with the wire marking device being moved from left to right.

In an embodiment, the wire entry opening 110 is a channel 114 in the front end 102 of the wire marking device 100. The channel 114 is wider than an electrical wire, for example between about ⅕ and ⅛ of an inch. In alternative embodiments, the channel 114 can be sized to accommodate any sized wire, including but not limited to any wire sized within the American Wire Gauge standard between AWA 0000 through 40. Accordingly, in embodiments, the wire entry opening 110, channel 114 and other aspects of the wire marking device 100 are sized to accommodate any sized wire, including very fine wires or larger wires and cables.

In an embodiment, near a top 118 of the wire marking device 100, the channel 114 has a horizontal portion 122 extending laterally from a side portion 116 of the front end 102, with the channel 114 extending laterally into the wire marking device 100 approximately half way into the circular cross section of the device 100. In embodiments, the horizontal portion 122 is approximately between ½ to 2 inches from the top 118 of the wire marking device, and in one embodiment is about 1 inch from the top 118. Then, at approximately half way into the circular cross section of the device 100, the channel 114 has a longitudinal (or vertical) portion 124 extending towards the top 118 of the device 100. In embodiments, the longitudinal portion 124 extends until approximately between ¼ to 1 inch from the top 118, and in one embodiment until about ⅜ inch from the top 118. In embodiments, the channel 114 has square corners 120, and in other embodiments, the channel has rounded corners 120. Other dimensions are possible, and the relative position and sizing of the channel 114 varies according to the specific application, including the size of the wire desired to be marked and the size of the marker 108 to be placed within the wire marking device 100.

The tubular passage 105 of the wire marking device 100 extends from the circular marker opening 106 at the back end 104 of the device 100 though the central portion of the device 100 up to the wire entry opening 110. In embodiments, the tubular passage 105 is substantially shaped slightly larger than a desired marker 108 such that the marker 108 fits snugly within the tubular passage 105 extending into the wire entry opening 110 and the marking end 109 of the marker 108 extends into the longitudinal portion 124 of the channel 114. In other embodiments, the tubular passage 105 varies in size depending on the size of the marker being used. In other embodiments, the tubular passage 105, circular marker opening 106, and other aspects of the wire marking device 100 is sized to accommodate any sized marker, including larger and smaller markers.

In embodiments, the tubular passage 105 is substantially shaped slightly larger than a permanent marker, such as a Sharpie Fine Point Permanent Marker (MSDS #30000) or an Avery Marks-A-Lot Permanent Felt-Tip Marker. Preferably, the wire marking device 100 and tubular passage are designed to accommodate a marker 108 that comes in a variety of colors, such as the Sharpie Fine Point Permanent Markers, so that a variety of colors can be used within the marking device 100 to mark different wires with different colors. In embodiments, other wiring implements, such as pens, markers, paint applicators or other devices for marking a wire may be used in place of the marker 108. In embodiments, the tubular passage 105 of the marking device 100 is substantially shaped slightly larger than the cross sectional dimensions of the writing implement such that the writing implement is held in a fixed location within the marking device 100 and can mark the wire 112 that is inserted in the channel 114. In embodiments, the tubular passage 105 is sized to allow the desired marking device 100 to fit snugly within the passage 105, and in other embodiments the tubular passage 105 is sized to allow the desired marking device 100 to fit loosely within the passage 105.

In embodiments, the tubular passage 105 on the marking device 100 is shorter in length than the marker 108 such that when the marker 108 is within the tubular passage 105, at least some of a back portion 132 of the marker 108 extends outside the circular marker opening 106 sufficient to allow a user to grip or put a finger on the back portion 132. Thus, in these embodiments, a user can remove the marker 108 from the marking device 100 by pulling on the back portion 132 of the marker. In other embodiments, the tubular passage 105 on the marking device 100 is longer in length than the marker 108.

In embodiments, a diameter of the circular marker opening 106 and a first portion 126 of the tubular passage 105 is approximately ½ inch and a length of the first portion 126 is approximately 3 inches. In other embodiments, the diameter and length varies, for example, in embodiments the diameter of the circular marker opening 106 and the first portion 126 of the tubular passage 105 is approximately between ¼ to 1 inch and a length of the first portion 126 is approximately between 1 to 5 inches.

In embodiments, the first portion 126 of the tubular passage 105 is followed by a second portion 128 of the tubular passage 105. In an embodiment, the second portion 128 is approximately 4/9 inch or about 0.422 inches in diameter and about 7/9 inch or about 0.789 inches long. The second portion 128 of the tubular passage 105 extends into the wire entry opening 110. In other embodiments, the diameter and length varies, for example, in embodiments the diameter of the second portion 128 of the tubular passage 105 is approximately between ¼ to 1 inch and the length of the second portion 128 is approximately between ½ to 2 inches.

The dimensions discussed herein are for illustration purposes, other dimensions are possible, with the relative position and sizing of the wire marker device 100, including but not limited to its various parts, such as the tubular passage 105, circular marker opening 106, channel 114, and other portions, vary according to the specific application, including the size of the wire 112 desired to be marked and the size of the marker 108 to be placed within the wire marking device 100.

At the end of the second portion 128 of the tubular passage 105 is an end passage 134 that extends into the longitudinal portion 124 of the channel 114. The end passage 134 has ledges 136 that stop the marker 108 from being pushed farther into the wire marking device 100. The ledges 136 hit a corresponding marking device front end 138 when the marker 108 has been fully inserted into the tubular passage 105 of the wire marking device 100.

Once a marker 108 has been fully inserted into the wire marking device 100, the marking end 109 of the marker 108 is held within the longitudinal portion 124 of the channel 114. The marking end 109 can then mark a portion of a wire 112 inserted into the channel 114. The marker 108 can be used quickly and efficiently to mark multiple wires 112, each with a different color marker. For example, a user can use the marking device 100 by inserting a first wire 112 in the device 100, placing a first color marker in the device, marking the first wire with the first color, removing the first color marker and first wire from the device, inserting a second wire 112 in the device 100, inserting a second color marker in the device, marking the second wire with the second color, and repeating this process for each wire and each color desired to be marked.

In embodiments, the wire marking device 100 is accompanied by a case 140 that is shaped to hold a wire marking device 100 and one or more markers 108. The case 140 provides a convenient place to store and carry the wire marking device 100 and one or more markers 108, preferably several markers 108 to allow multiple colors to be used, one color per wire 112 to be marked.

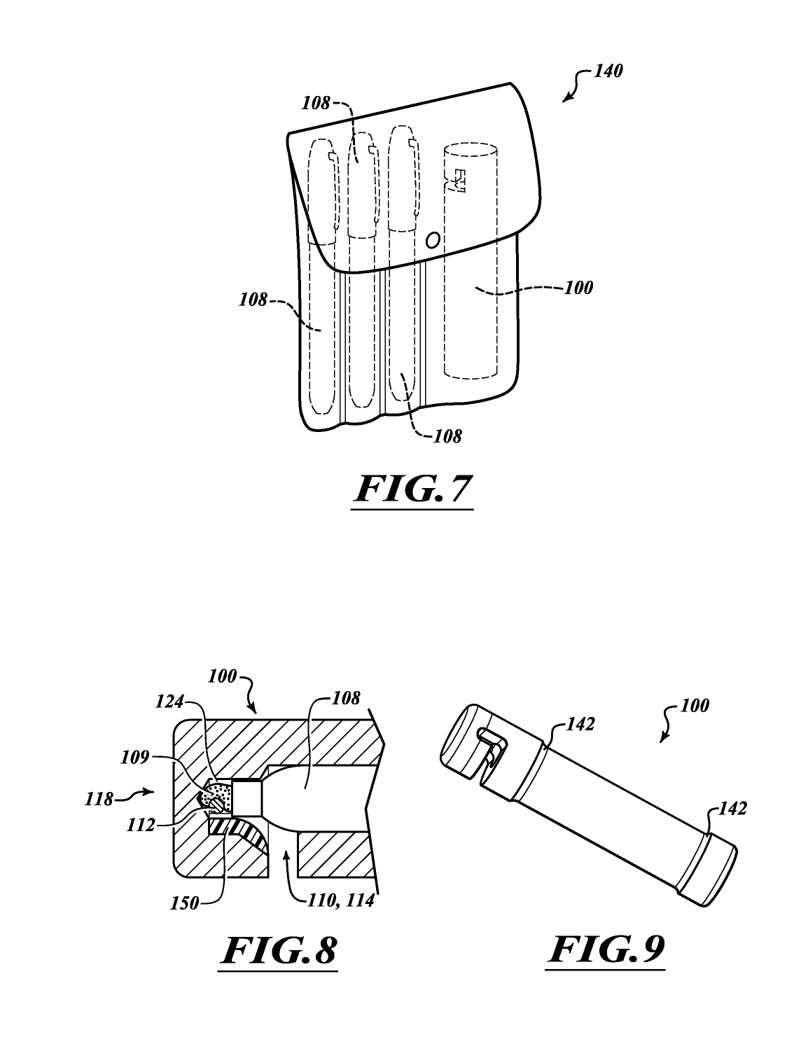

In embodiments, the wire marking device 100 can include a shaped outer surface to facilitate a user's handling of the device 100. For example in an embodiment, the device 100 has an indented surface on a portion of the outer surface of the tubular body. In other embodiments, a handling grip, surface indicia, colors, labels, textures, and various shapes can be formed on the outer surface of the device 100. For example, as shown in FIG. 9, the wire marking device 100 has a contoured outer surface 142 where a user can grip the wire marking device 100 between the contours 142.

A method of using the wire marking device 100, illustrated by FIGS. 4-6, includes placing a first color marker 108 into the circular marker opening 106 and partially into the tubular passage 105 of the wire marking device 100, inserting a first wire 112 into the channel 114 such that the first wire 112 enters the longitudinal portion 124 of the channel 114, and pressing the first color marker 108 the rest of the way into the tubular passage 105 of the wire marking device 100 such that the marking end 109 of the first color marker 108 is in contact with the first wire 112. Then, with the first wire 112 engaged in the wire marking device 100 and in contact with the marking end 109 of the first color marker 108, moving the wire marking device 100 along the length of the first wire 112 such that the first wire 112 is marked by the marking end 109 of the first color marker 108 over a longitudinal section of the wire 112. After marking the first wire 112 with a first color, the first color marker 108 and the first wire 112 are removed from the wire marking device 100.

Then, placing a second color marker 108 into the circular marker opening 106 and partially into the tubular passage 105 of the wire marking device 100, inserting a second wire 112 into the channel 114 such that the second wire 112 enters the longitudinal portion 124 of the channel 114, and pressing the second color marker 108 the rest of the way into the tubular passage 105 of the wire marking device 100 such that the marking end 109 of the second color marker 108 is in contact with the second wire 112. Then, with the second wire 112 engaged in the wire marking device 100 and in contact with the marking end 109 of the second color marker 108, moving the wire marking device 100 along the length of the second wire 112 such that the second wire 112 is marked by the marking end 109 of the second color marker 108.

This process can be repeated for as many wires or as many colors are required or desired. The method may be modified as well, including for different embodiments of the wire marking device 100. In alternative methods, the wire 112 is inserted into the longitudinal portion 124 of the channel 114 before the marker 108 is inserted into the circular marker opening 106 or the tubular passage 105 of the wire marking device 100. In other alternative methods, the marker 108 is inserted into the circular marker opening 106 and completely into the tubular passage 105 of the wire marking device 100 before the wire 112 is inserted into the channel 114.

Alternative embodiments of the wire marking device 100 includes embodiments that have larger or alternative wire entry openings 110 or channels 114. For example, in alternative embodiments, the wire entry opening 110 and channel 114 is configured to permit the wire 112 to enter and exit the longitudinal portion 124 of the channel 114 when the marker 108 is fully within the tubular passage 105 of the wire marking device 100 and the marking end 109 is within the longitudinal portion 124 of the channel 114.

As shown in FIG. 8, an alternative embodiment of the wire marking device 100 has a flexible portion 150 within the channel 114 that allows the wire 112 to be inserted into the longitudinal portion 124 of the channel 114 when a marker 108 is fully engaged in the tubular passage 105 and the marking end 109 is within the longitudinal portion 124 of the channel 114. When the wire 112 is inserted into the channel 114 and pressed against the flexible portion 150, the flexible portion 150 allows the wire 112 to pass through the longitudinal portion 124 of the channel 114 while the wire 112 presses against the marker 108 and the flexible portion 150. The flexible portion 150 also presses the wire 112 against the marking end 109 of the marker 108 when the wire 112 and marking end 109 are in the longitudinal portion 124. In another alternative embodiment, the flexible portion 150 is absent from FIG. 8, leaving extra space within the channel 114 that allows the wire 112 to be inserted into and removed from the longitudinal portion 124 of the channel 114 when a marker 108 is fully engaged in the tubular passage 105 and the marking end 109 is within the longitudinal portion 124 of the channel 114.

Also, in embodiments, the wire 112 can be marked along a short section of its length or along a longer section of its length, including marking the entire length of the wire. Also, in embodiments, the wire 112 may be marked with multiple colors in different sections around its perimeter.

It is contemplated that depending on the size, shape, and/or other configuration of the object desired to be marked and the writing implement, a wire marking device according to the present disclosure can vary. For example, the wire marking device 100, and any of its various parts, for example the circular marker opening 106, tubular passage 105, channel 114, and wire entry opening 110, can be angular, such as rectangular, triangular or square, and may be of varying dimensions, including but not limited to varying sizes, widths and lengths, to accommodate different types of writing implements and different shaped wires or objects to be marked. Moreover, the wire marking device may also have different sized and shaped openings for slidably receiving various shaped wires or elongated objects desired to be slidably marked. Any specific dimension provided herein is for illustration purposes only for specific embodiments.

As demonstrated herein a wire marking device according to embodiments of the present disclosure provide a device that holds a writing implement such as a marker in a fixed orientation, where the device comprises an elongated body with a first open end configured to receive the writing implement and a second end configured to slidably receive a wire, for example an electrical wire, wherein the device is configured to hold the writing implement such that a writing tip of the writing implement is within the second end of the device such that when the wire is slidably received within the second end, the writing tip of the writing implement marks the wire. The components of the various embodiments can be fabricated from any suitable material including metals, woods, foams, composites, or any other suitable material.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wire marking device comprising an elongated body with a first open end configured to receive a writing implement and a second end comprising a channel configured to slidably receive an electrical wire, the device further comprising a tubular passage within the elongated body configured to hold the writing implement in a fixed location with a writing tip of the writing implement within the second end of the device such that when an electrical wire is slidably received within the channel, the writing tip of the writing implement marks the wire.

2. The device of claim 1 further comprising a holder configured to hold the wire marking device and a plurality of writing implements.

3. The device of claim 1 further comprising a shaped outer surface configured for a user's hand.

4. A wire marking device comprising:
an elongated body with a front end, back end, a circular cross-section, and a tubular passage;
the back end comprising a circular opening sized to receive a marking device into the tubular passage;
the tubular passage configured to hold the marking device in a fixed orientation such that a marking end of the marking device is held within the front end of the marking device when the marking device is within the tubular passage, the tubular passage substantially shaped slightly larger than the marking device such that the marking device fits snugly within the tubular passage; and
the front end comprising a channel configured to slidably receive a wire;
the channel extending substantially in an L-shape from a side portion of the front end of the marking device, with the channel extending laterally from the side portion of the front end and then extending longitudinally upwards in the front end,
wherein, when the wire is engaged within the channel and the marking device is inserted into the tubular passage, a marking end of the marking device touches the wire and marks the wire as the device is slid along a length of the wire.

5. The device of claim 4 further comprising a flexible portion within the channel, wherein the flexible portion is configured to allow the wire to engage within the channel when the marking device is inserted into the tubular passage and the marking end is within the channel.

6. A method of using a wire marking device, the method comprising:
providing wire marking device comprising an elongated body with a first open end configured to receive a marker, a second end comprising a channel configured to slidably receive a wire, and a tubular passage within the elongated body configured to hold the marker in a fixed location with a writing tip of the marker within the second end of the marking device;
inserting a first marker of a first color into the first open end of the wire marking device;
inserting a portion of a first wire into the second end of the marking device;
pushing the first marker into the wire marking device such that a marking end of the first marker is within the second end of the marking device;
moving the marking device lengthwise along the first wire such that the marking end of the first marker marks the first wire with the first color;
removing the first marker from the marking device;
removing the first wire from the marking device;
inserting a second marker of a second color into the first open end of the wire marking device;
inserting a portion of a second wire into the second end of the marking device;
pushing the second marker into the wire marking device such that a marking end of the second marker is within the second end of the marking device;
moving the marking device lengthwise along the second wire such that the marking end of the second marker marks the second wire with the second color;
removing the second marker from the marking device; and
removing the second wire from the marking device.

7. The method of claim 6, wherein the pushing the first marker into the wire marking device such that a marking end of the first marker is within the second end of the marking device occurs before the inserting a portion of a first wire into the second end of the marking device, and wherein the pushing the second marker into the wire marking device such that a marking end of the second marker is within the second end of the marking device occurs before the inserting a portion of a second wire into the second end of the marking device.

8. The method of claim 6, wherein the removing the first wire from the marking device occurs before the removing the first marker from the marking device, and wherein the removing the second wire from the marking device occurs before the removing the second marker from the marking device.
